(19) United States
(12) Patent Application Publication
(10) Pub. No.: US 2025/0379766 A1
(43) Pub. Date: Dec. 11, 2025

(54) Method and apparatus for a receiver for orthogonal frequency division multiplexing signals with strong nonlinear distortion effects

(71) Applicants: INSTITUTO DE TELECOMUNICAÇÕES, AVEIRO (PT); UNIVERSIDADE NOVA DE LISBOA, LISBOA (PT); COFAC - COOPERATIVA DE FORMAÇÃO E ANIMAÇÃO CULTURAL, CRL, LISBOA (PT)

(72) Inventors: DANIEL MACEDO DINIS, LISBOA (PT); DIOGO MIGUEL BATISTA DE SOUSA CORREIA DA COSTA, LISBOA (PT); JOÃO FRANCISCO MARTINHO LÊDO GUERREIRO, CAPARICA (PT); RUI MIGUEL HENRIQUES DIAS MORGADO DINIS, CAPARICA (PT); PAULO MIGUEL ARAÚJO BORGES MONTEZUMA DE CARVALHO, CAPARICA (PT)

(73) Assignees: INSTITUTO DE TELECOMUNICAÇÕES, AVEIRO (PT); UNIVERSIDADE NOVA DE LISBOA, LISBOA (PT); COFAC - COOPERATIVA DE FORMAÇÃO E ANIMAÇÃO CULTURAL, CRL, LISBOA (PT)

(21) Appl. No.: 19/232,259

(22) Filed: Jun. 9, 2025

(30) Foreign Application Priority Data
Jun. 8, 2024 (PT) 119514

(51) Int. Cl. H04L 25/02; H04L 5/00; H04L 27/34

(52) U.S. Cl. CPC H04L 25/021; H04L 5/0007; H04L 5/0098; H04L 27/34

(57) ABSTRACT

An iterative receiver for orthogonal frequency division multiplexing signals with strong nonlinear distortion effects that takes advantage of the spreading of the signal associated to a given subcarrier through all subcarriers by the nonlinear operation at the transmitter. This receiver estimates iteratively the signal associated to a given subcarrier using the contributions from the received signals associated to all subcarriers, as well as the estimates of transmitted signals of those subcarriers from the previous iteration.

### CROSS-REFERENCE TO RELATED APPLICATIONS

This application claims the benefit of priority under 35 U.S.C. § 119(c) from Portugal Patent Application No. 119514, filed Jun. 8, 2024, which is hereby incorporated by reference as if set forth in its entirety herein.

### TECHNICAL FIELD

The present disclosure relates generally to receivers for orthogonal frequency division multiplexing (OFDM) apparatus for use in both coded and uncoded schemes in telecommunication systems. More particularly, the present disclosure relates to a receiver capable of taking advantage of the strong nonlinear distortion effects and exploit the frequency diversity introduced by the nonlinear operation at the transmitter. The receiver apparatus estimates iteratively the signal associated to a given subcarrier using the contributions from the received signals associated to all subcarriers, as well as the estimates of transmitted signals of those subcarriers from the previous iteration.

### BACKGROUND

Orthogonal frequency division multiplexing (OFDM) [1] has been the standard waveform of wireless communications for more than one decade and is also being appointed to support the PHY layer of beyond fifth generation (5G) and sixth generation (6G) communications [2]. The option for OFDM is mainly a consequence of its case of implementation that relies on simple digital signal processing (DSP), its high flexibility allowing for power loading over the subcarriers, and its multipath robustness [3]. Despite these advantages, OFDM is known to suffer from amplification issues caused by the large peak-to-average power ratio (PAPR) of the modulated signals [4], [5]. To accommodate the large envelope fluctuations of OFDM signals in the linear range of the power amplifier (PA) and avoid nonlinear distortion, a large back-off should be adopted. Consequently, the energy efficiency of the amplification process can be severely degraded [6], [7]. The high PAPR makes also OFDM signals very sensitive to energy-efficient, low-resolution digital-to-analog converters (DACs), which can be another source of nonlinear distortion [8]. In addition, even the most efficient techniques to reduce the PAPR, which involve a digital clipping operation, give rise to nonlinearly distorted signals [9]. As a result, energy efficiency and linearity are conflicting goals in OFDM transmissions [10]. Therefore, since one of the most important objectives of 6G is to have energy efficient transmissions [11], it is expected that nonlinear (NL) effects in OFDM signals will remain persistent and difficult to avoid.

The harmful effects of NL distortion can be separated in two terms, namely an in-band distortion term that can degrade the performance [12], and an out-of-band term that leads to spectral widening effects and compromise the compliance with the spectral mask [13]. Since OFDM signals are usually approximated by Gaussian random process [14], one can employ the Bussgang's decomposition to characterize the nonlinearly distorted signals [15]. Bussgang's theorem states the nonlinearity output can be written as the sum of a signal proportional to the input and a distortion term. This decomposition enables the design of receivers that to mitigate the in-band distortion by estimating it and canceling it from the received signal [16]. These receivers can reduce nonlinear distortion effects at the detection level, especially in moderate and high signal-to-noise ratio (SNR) regions. However, for low SNR values, the error propagation effects might be intolerable.

Although NL effects are commonly seen as a noise term, they are not random. In fact, they are a deterministic function of the transmitted data and therefore have useful information that can potentially be used for detection purposes. However, since this information is spread in all subcarriers, it cannot be exploited by conventional one-tap OFDM receivers that perform detection on a subcarrier basis. To take advantage of the information of the NL distortion, the optimum maximum likelihood (ML) receiver should be employed, since it per-forms a block-by-block basis detection [17]. The usefulness of the nonlinear distortion is such that the performance of NL OFDM with ML receivers can be even better than linear OFDM performance [18]. However, ML receivers involve an exhaustive search to detect a single OFDM block, which precludes their practical implementation. For this reason, studying the ML performance of nonlinearly distorted OFDM is a complicated task. Nevertheless, the potential gains of ML detection can be theoretically computed when the number of subcarriers is large and for high SNRs values [18]. In fact, asymptotic gains of ML detection of NL OFDM were shown to be surprisingly high, regardless of the kind of nonlinearity [19]. More recently, nonlinearities that maximize those potential asymptotic gains were derived [20].

The method and apparatus disclosed in current application is an iterative receiver that can approach the ML performance with moderate complexity, by taking advantage of nonlinear distortion for detection purposes and exploit the frequency diversity introduced by the nonlinear distortion. In recent years, several sub-optimal receivers have been proposed. For instance, documents [19] and [21] disclose sub-optimal receivers based on the ML detection principle. The methods disclosed in [19,21] present performance improvements relative to linear OFDM and despite the reduction of the search set of the possible transmitted sequences their complexity is still very high. Moreover, they are not suitable to coded OFDM schemes as the receiver disclosed in current application.

Another suboptimal receiver based on the generalized approximate message passing (GAMP) concept is disclosed in [22], but its complexity is still too high since it involves solving a large number of 1-D or 2-D integrals for each symbol. Document [23] discloses a Fast-GAMP receiver with much lower complexity than the conventional GAMP, but at a cost of severe performance degradation, not being able to approach the linear OFDM performance as the receiver disclosed herein.

Contrarily to Bussgang receivers of [24] that only try to remove nonlinear distortion, our receiver aims to take advantage of the information inherent to it to improve the performance, which is in fact far away from what is teached in [24]. Although GAMP-based receivers have the same goal, our approach is completely different, since it does not require complex matrix operations and the propagation of correlation estimates. It also does not require the evaluation of integrals, whose complexity increases with the constellation size. Our receiver has a complexity that is almost independent of the constellation size and can easily adapted to coded scenarios. Having in mind the main characteristics of the method and apparatus disclosed in current application, it follows that has no relation with the techniques referred in documents and [21-24].

### BRIEF SUMMARY OF THE DISCLOSURE

The method and apparatus devised for a receiver handling OFDM signals with strong nonlinear distortion effects not only effectively compensates for these distortions but also take advantage of such nonlinear distortion to improve its performance. Unlike conventional OFDM receivers which suffer from compromised performance in the presence of strong nonlinearities, the receiver disclosed herein approximates the performance of the optimal Maximum Likelihood (ML) receiver with reduced computational complexity.

The receiver method and apparatus leverage a highly precise characterization of how the signal associated with an OFDM subcarrier distributes across other subcarriers. This characterization enables Maximum Ratio Combining (MRC) detection of the signal associated with a specific subcarrier, provided that the signals associated with the remaining subcarriers are known. To achieve this, an iterative detection approach is employed, utilizing estimates of data associated with subcarriers k≠k₀ from the previous iteration to estimate the signal associated with subcarrier k₀. This process is repeated for all subcarriers (k₀=1,2, . . . , N) to obtain an updated estimate of the transmitted block, iterating until convergence of the estimates is achieved.

The receiver of current application demonstrates versatility by seamlessly handling signals with or without channel coding. In one embodiment without of coding schemes, estimates are derived as average values computed from the Log-Likelihood Ratio (LLR). In embodiments where coding is employed, estimates rely on the outputs provided by a channel decoder.

Embodiments of the receiver method and apparatus may be employed across various constellations utilized in the OFDM signal and levels of oversampling and can cope with both digital and analog nonlinearities. In another embodiment it is employed a digital filtering to filter the nonlinearity output and reduce the out-of-band radiation associated with nonlinearity distortion effects.

Embodiments consistent with the disclosure can be implemented purely digitally using only samples of the received signal and assuming the channel is known as well as the nonlinearity function used in the transmitter.

Additional features and advantages of embodiments consistent with the disclosure will be set forth in the description that follows. Yet, further features and advantages will be apparent to a person skilled in the art based on the description set forth herein or may be learned by practice of the disclosure. It is to be understood that both the following detailed description is exemplary and explanatory and is intended to provide further explanation of embodiments consistent with the disclosure, as claimed.

Embodiments consistent with the disclosure are defined in the dependent claims. Other objects, advantages and novel features of the present disclosure will become apparent from the following detailed description of certain embodiments consistent with the disclosure when considered in conjunction with the accompanying drawings and claims.

### BRIEF DESCRIPTION OF DRAWINGS

The various aspects of the embodiments disclosed here, including features and advantages of the present disclosure outlined above, are described more fully below in the detailed description in conjunction with the drawings, where like reference numerals refer to like elements throughout, in which:

FIG. 1 is a process flowchart embodiment for a receiver for orthogonal frequency division multiplexing signals with strong nonlinear distortion effects.

FIG. 2 is a block diagram that illustrates an exemplary of a receiver for orthogonal frequency division multiplexing signals with strong nonlinear distortion effects.

FIG. 2a is a block diagram that illustrates an exemplary of a receiver for orthogonal frequency division multiplexing signals with strong nonlinear distortion effects with filtering to reduce out-of-band radiation due to nonlinear distortion.

FIG. 3 is a block diagram that illustrates an exemplary of the iterative receiver block 212 of FIG. 2.

FIG. 4 is a block diagram that illustrates an exemplary of the block 306 of FIG. 3 corresponding to the conditional detection of a given subcarrier.

### DETAILED DESCRIPTION OF CERTAIN EMBODIMENTS ACCORDING TO THE DISCLOSURE

Methods, apparatuses, and systems for orthogonal frequency division multiplexing signals with strong nonlinear distortion effects are disclosed herein.

Some definitions are provided here only for convenience purposes but are not limiting. The meaning of these terms will be apparent for a person skilled in the art based on the entirety of the teachings provided herein.

Let us consider OFDM signals composed by N active subcarriers and possibly with additional subcarriers of oversampling. The transmitted data is defined in the frequency domain as X=[0, . . . , 0, X₁, X₂, . . . , X_{N}, 0, . . . , 0], where Xₖ is a data symbol selected from a given M-ary quadrature amplitude modulation (M-QAM) constellation. Note that as a convention values in the frequency domain are represented by uppercase letters, while their counterparts in the time domain are denoted by lowercase letters.

The nonlinearly distorted OFDM samples are defined as z=f(x)=A(|x|)e_{jΘ(|x |)}e_{jφ}, in which f(x) represents the bandpass nonlinearity function in question, where q =arg (x) is the angle of the time-domain sample x, |x| denotes the absolute value of the sample and A(|x|) and Θ(|x |) denote the amplitude modulation-to-amplitude modulation (AM-AM) and amplitude modulation-to-phase modulation (AM-PM) nonlinear characteristics, respectively.

The Gaussian approximation for the time-domain samples allows us to write the nonlinearly distorted OFDM signal as z=f(x)=αx+d, where d concerns the nonlinear distortion, which is uncorrelated with the nonlinearity input, and α is a scale factor, further referred as Gaussian approximation scale factor (GASF). Using a Fourier Transform the frequency-domain version of the nonlinearly distorted OFDM signal is Z=F(z)=αx+D, where X can be accurately modeled by a Gaussian-distributed random variable with zero mean and variance σ_{X}².

Having into consideration the channel frequency response H and the frequency-domain version of the additive white Gaussian noise (AWGN) N, the received signal can be given by Y=Z⊙H+N, where ⊙ denotes the pointwise multiplication of the two vectors, while H is an estimative of the channel, and the variance of the noise is given by σ_{N}2.

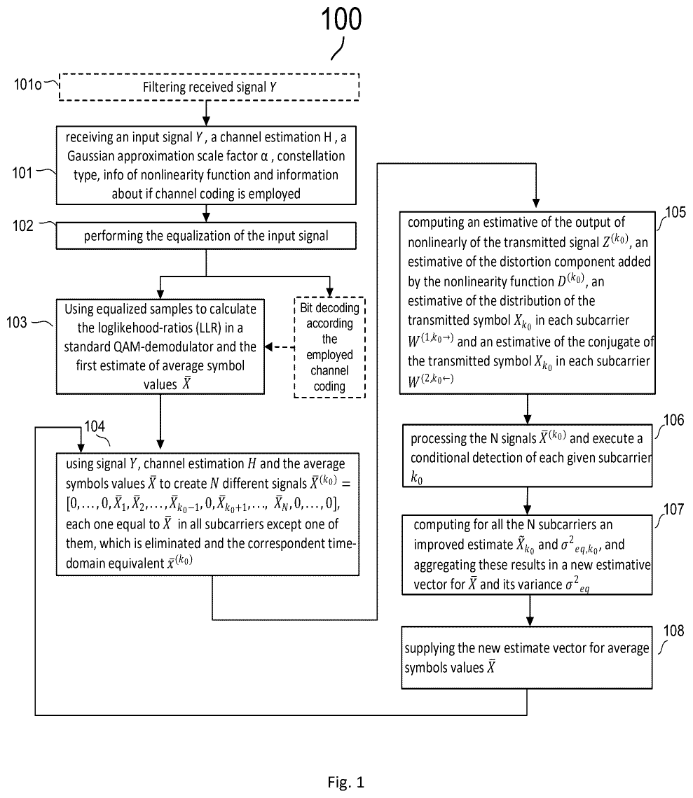

The operation of the several embodiments shall be described further with reference to the flowchart of FIG. 1. Steps related to coded OFDM signals are represented with dashed lines. The process starts at step 101, that includes receiving an input signal Y resulting from the propagation of a nonlinearly distorted OFDM signal through a channel H, receiving a channel estimation H, a Gaussian approximation scale factor α, information about the constellation type, information about nonlinearity function used by the transmitter and information about if channel coding is employed.

As will be appreciated, the processes described herein can be performed by a hardware device that is configured by code, for example, to process signals and provide outputs (e.g., a physical processor or a virtual processing unit operating on another hardware device). The code can be provided by a non-transitory computer readable medium, such as RAM as one non-limiting example. As is generally understood, processors are configured by code provided from memory to implement the various steps described below (e.g., equalization as at step 103, or calculation of LLRs as in step 103, etc.). The code can include instructions to the processor to implement one or more algebraic or other equations, including the equations described in detail below.

Step 102 includes performing the equalization of the input signal Y by dividing each frequency domain sample of the input signal by the corresponding channel coefficient to obtain for each sub-carrier sample

$${\tilde{X}}_{k} = \frac{{Y}_{k}}{{H}_{k}} ,$$

with k=1, . . . , N, where N denotes the number of subcarriers of OFDM signal.

Step 103 receives the set of equalized samples \tilde{X}ₖ, k=1, . . . , N, which is used to calculate the loglikehood-ratios (LLR) in a standard QAM-demodulator and the first estimate of average symbol values X̅. In another embodiment includes an optional step 103o, to deal with channel coding in which these LLR are used in a decoder adequate for the employed error correction codes.

Step 104 uses signal Y, the channel estimation H and the average symbols values X̅ to create N different signals X̅^{(k}^{₀}⁾=[0, . . . , 0, X̅₁, X̅₂, . . . , X̅ₖ_{₀}₋₁, 0, X̅ₖ_{₀}₊₁, . . . , X̅_{N}, 0, . . . , 0], each one equal to X̅ in all subcarriers except one of them, which is eliminated and the correspondent time-domain equivalent x̅^{(k}^{₀}⁾.

Step 105 includes computing an estimative of the output of nonlinearly of the transmitted signal Z^{(k}^{₀}⁾, an estimative of the distortion component added by the nonlinearity function D^{(k}^{₀}⁾, an estimative of the distribution of the transmitted symbol Xₖ_{₀} in each subcarrier W^{(1,k}^{₀}^{→)} and an estimative of the conjugate of the transmitted symbol Xₖ_{₀} in each subcarrier W^{(2,k}^{₀}^{←)}.

Step 106 includes processing the N signals X̅^{(k}^{₀}⁾and execute a conditional detection of each given subcarrier k₀.

Step 107 includes computing for all the N subcarriers an improved estimate \tilde{X}k0 and σ²_{eq,k}_{₀}, and aggregating these results in a new estimative vector for X̅ and its variance σ²_{eq}.

Step 108 includes supplying the new estimate vector for average symbols values X̅ to Step 104.

Steps 104 to 108 are iterative steps that may be executed i times according to the desired number of iterations.

In another embodiment an optional step 1010 includes a digital filtering to remove the out-of-band radiation associated with the NL distortion effects, by replacing the samples Zₖ of nonlinear distorted signal by Zₖ×Fₖ, where Fₖ=0 for the out-of-band subcarriers and 1 for the in-band subcarriers. This filtering effect can also be instead included in Hₖ (i.e., by replacing Hₖ by Hₖ×Fₖ). In another embodiment optional step 101o includes an analog filtering to remove the out-of-band radiation associated with the NL distortion effects.

To simplify our notation, in the following we will ignore the post-nonlinearity filtering, although it will be implicit according to the context.

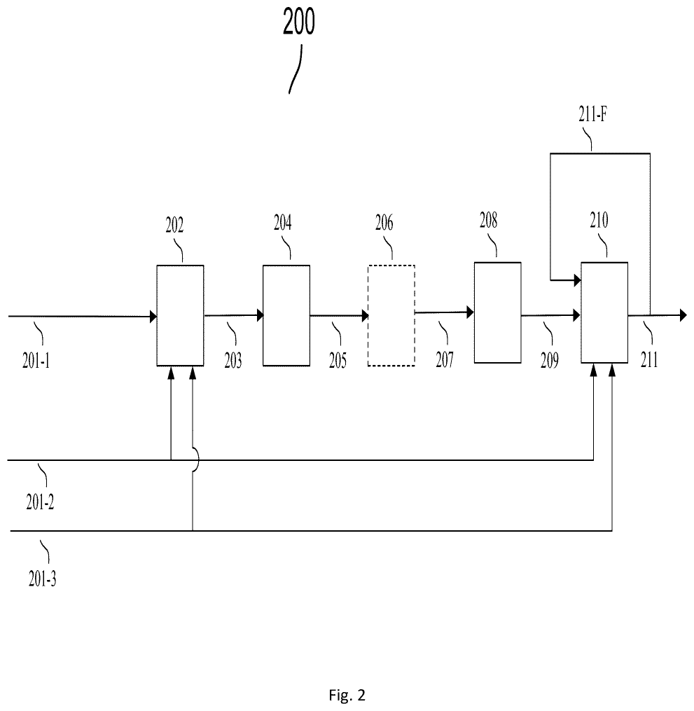

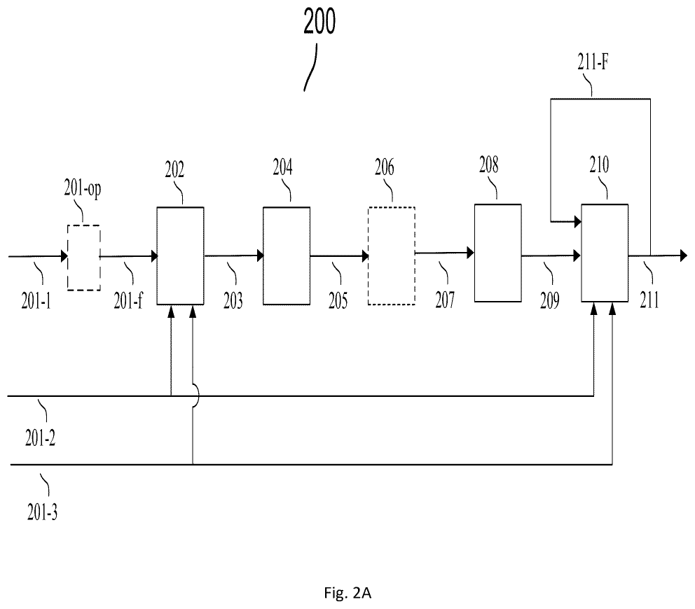

Block diagram 200 of FIG. 2 is an example that illustrates an exemplary apparatus embodiment implementing the process flowchart 100 of FIG. 1. In the example of FIG. 2, block related to coded OFDM signals are represented with dashed line. In the example of FIG. 2, it is received as input signal 201-1 the receiver signal Y resulting from the propagation of a nonlinearly distorted OFDM signal through the channel H. The block 202 performs the equalization of the input signal 201-1 done by the following expression for each frequency-domain sample:

$${\tilde{X}}_{k} = \frac{{Y}_{k}}{{H}_{k}} ,$$

resulting in signal 203. This signal goes through block 204 that is a M-QAM demodulator which turns the input into loglikehood-ratios (LLR) 205 to perform this operation the variance of the signal 203 must be provided, which is calculated as follows:

$${σ}_{203}^{2} = \frac{{σ}_{D}^{2}}{{α}^{2}} + \frac{{σ}_{N}^{2}}{{α}^{2} {\vert H \vert}^{2}} .$$

If is employed channel coding these LLR are used by a decoder suitable for the error correction codes employed in the transmission, represented by the block 206 that has as output the LLR of the different bits 207. In order to covert these bits into average symbols values the block 208 is used. In first iteration the iterative receiver block 210 receives in addition to signal 209 the channel estimation H 201-2 and the signal Y 201-1, producing the signal 211, which is the estimated average symbols values X̅ of the OFDM signal, from which obtaining the corresponding bits is trivial. In iterations with i>1, instead of signal 209, block 210 receives signal 211-F, with the feedback from previous iteration of estimated average symbols values X̅. In embodiment of FIG. 2a, it is employed a filter 201-op to remove the out-of-band radiation associated with the NL distortion effect, and the filtered signal 201-f is provided to block 202.

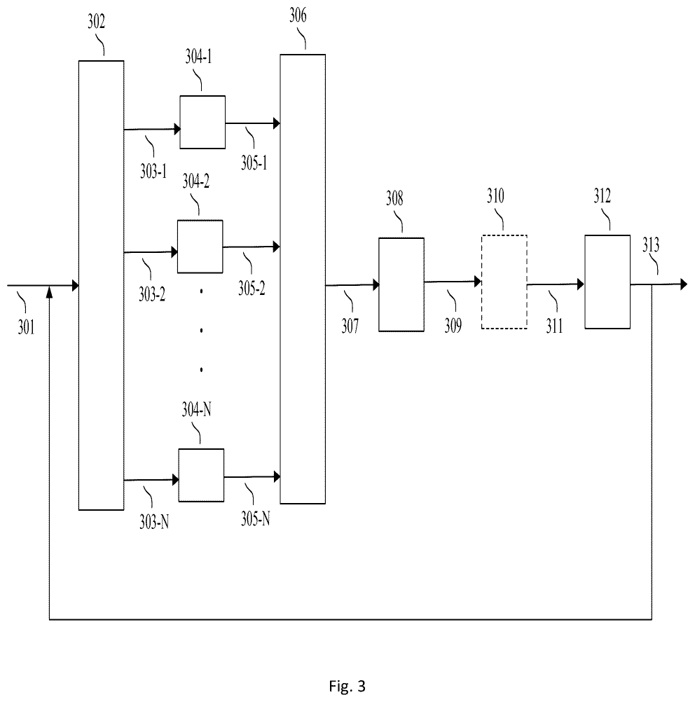

Block diagram 300 of FIG. 3 is an example that illustrates an exemplary apparatus embodiment implementing the block 210 of FIG. 2. In the example of FIG. 3, optional blocks related to coded OFDM signals are represented with dashed line. In the example of FIG. 3, it is received as input signal 301-1 which is the average symbols values X̅ in 209 of FIG. 2. The block 302 creates N different signals each one equal to X̅ in all subcarriers except one of them, which is eliminated as presented in the following expression:

$${\overline{X}}^{( {k}_{0} )} = [ 0 , … , 0 , {\overline{X}}_{1} , {\overline{X}}_{2} , … , {\overline{X}}_{{k}_{0} - 1} , 0 , {\overline{X}}_{{k}_{0} + 1} , … , {\overline{X}}_{N} , 0 , … , 0 ] .$$

These N signals represented by 303-1, 303-2 to 303-N are processed in the blocks 304-1, 304-2 to 303-N that are equal and execute a conditional detection of the given subcarrier k₀. These blocks in addition to the signal X̅^{(k}⁰⁾ receive the channel estimation H and the receiver signal Y 201-1 of FIG. 2 and produces as output from each of these crucial blocks an improve estimative of the subcarrier k₀ \tilde{X}ₖ_{₀} and its respective variance σ²_{eq,k}_{₀}, these values are obtained by the following expressions:

$$\begin{matrix}{\tilde{X}}_{{k}_{0}} = ( \frac{{\tilde{x}}_{{k}_{0}}^{( 1 )}}{{σ}_{eq , {k}_{0} , 1}^{2}} + \frac{{\tilde{x}}_{{k}_{0}}^{( 2 )}}{{σ}_{eq , {k}_{0} , 2}^{2}} + \frac{{\tilde{x}}_{{k}_{0}}^{( 3 )}}{{σ}_{eq , {k}_{0} , 3}^{2}} ) \times {σ}_{eq , {k}_{0}}^{2} , \\ {σ}_{eq , {k}_{0}}^{2} = {( \frac{1}{{σ}_{eq , {k}_{0} , 1}^{2}} + \frac{1}{{σ}_{eq , {k}_{0} , 2}^{2}} + \frac{1}{{σ}_{eq , {k}_{0} , 3}^{2}} )}^{- 1} ,\end{matrix}$$

where \tilde{X}ₖ_{₀}⁽ⁱ⁾ define three different estimates of \tilde{X}ₖ_{₀} given by:

$$\begin{matrix}{\tilde{X}}_{{k}_{0}}^{( 1 )} = \frac{{( {H}^{( 1 )} )}^{H} \times {V}^{( {k}_{0} )}}{{‖ {H}^{( 1 )} ‖}^{2}} , \\ {\tilde{X}}_{{k}_{0}}^{( 2 )} = \frac{{( {V}^{( {k}_{0} )} )}^{H} \times ( {H}^{( 2 )} )}{{‖ {H}^{( 2 )} ‖}^{2}} , \\ {\tilde{X}}_{{k}_{0}}^{( 3 )} = \frac{{Y}_{{k}_{0}} - {H}_{{k}_{0}} \times {D}_{{k}_{0}}^{( {k}_{0} )}}{∝ {H}_{{k}_{0}}} ,\end{matrix}$$

where V^{(k}^{₀}⁾ is an auxiliar vector that depends on k₀ and is given by:

$${V}^{( {k}_{0} )} = \{ \begin{matrix}{Y}_{k} - {H}_{k} \times {Z}_{k}^{( {k}_{0} )} , k \neq {k}_{0} \\ 0 , k = {k}_{0}\end{matrix} .$$

Additionally, the vectors H⁽¹⁾ and H⁽²⁾ are defined as

$${H}_{k}^{( 1 )} = {H}_{k} \times {W}_{k}^{( 1 , {k}_{0} \to )} and {H}_{k}^{( 2 )} = {H}_{k} \times {W}_{k}^{( 2 , {k}_{0} ← )} ,$$

where W^{(1,k}^{₀}⁾ and W^{(2,k}^{₀}⁾ represent the following Discrete Fourier Transforms:

$${W}^{( 1 , {k}_{0} )} = ℱ \{ \frac{{f}^{′} ( \vert {\overline{x}}^{( {k}_{0} )} \vert ) + \frac{f ( \vert {\overline{x}}^{( {k}_{0} )} \vert )}{\vert {\overline{x}}^{( {k}_{0} )} \vert}}{2} \} and$$

$${W}^{( 2 , {k}_{0} )} = ℱ \{ \frac{{f}^{′} ( \vert {\overline{x}}^{( {k}_{0} )} \vert ) - \frac{f ( \vert {\overline{x}}^{( {k}_{0} )} \vert )}{\vert {\overline{x}}^{( {k}_{0} )} \vert}}{2} \} ,$$

where x̅^{(k}^{₀}⁾ is the Inverse Fourier Transform of X̅^{(k}^{₀}⁾ and f and f′, represent the nonlinearity function and its derivative respectively. Note that W^{(1,k}^{₀}^{→)} is W^{(1,k}^{₀}⁾ with a cyclic rotation of

$$- \frac{N}{2} + {k}_{0} - 1 ,$$

while W^{(2,k}^{0←)} is W^{(2,k}^{₀}⁾ with a cyclic rotation in the opposite direction. Finally, to calculate σ²_{eq,k}_{₀} the variances of each estimative are required. Those variances are given by the following expressions:

$${σ}_{eq , {k}_{0} , 1}^{2} = \frac{{σ}_{N}^{2}}{{‖ {H}^{( 1 )} ‖}^{2}} + {σ}_{X}^{2} \times {\vert \frac{{( {H}^{( 1 )} )}^{H} {H}^{( 2 )}}{{‖ {H}^{( 1 )} ‖}^{2}} \vert}^{2} ,$$

$${σ}_{eq , {k}_{0} , 2}^{2} = \frac{{σ}_{N}^{2}}{{‖ {H}^{( 2 )} ‖}^{2}} + {σ}_{X}^{2} \times {\vert \frac{{( {H}^{( 1 )} )}^{H} {H}^{( 2 )}}{{‖ {H}^{( 2 )} ‖}^{2}} \vert}^{2} ,$$

$${σ}_{eq , {k}_{0} , 3}^{2} = \frac{{σ}_{N}^{2}}{{\vert ∝ \times {H}_{{k}_{0}} \vert}^{2}} .$$

For all the N subcarriers it is computed \tilde{X}ₖ_{₀}and the variance of estimates σ²_{eq,k}_{₀}, represented by 305-1, 305-2 to 305-N and those results are aggregated in a new estimative vector for X̅ 307 and its variance σ²_{eq} using block 306. This information is used to calculate the loglikehood-ratios (LLR) 309 using a standard QAM-demodulator represented by block 308. In embodiments with channel coding these LLR are used in a decoder adequate for the error correction codes in question, represented by the optional block 310 that has as output the LLR of the different bits 311.

In all embodiments, with or without channel coding, the signal 311 is converted into average symbols values 313 using the block 312, that operates in a similar way as block 208 of FIG. 2. These values are used iteratively in the receiver to obtain a better estimative of Y.

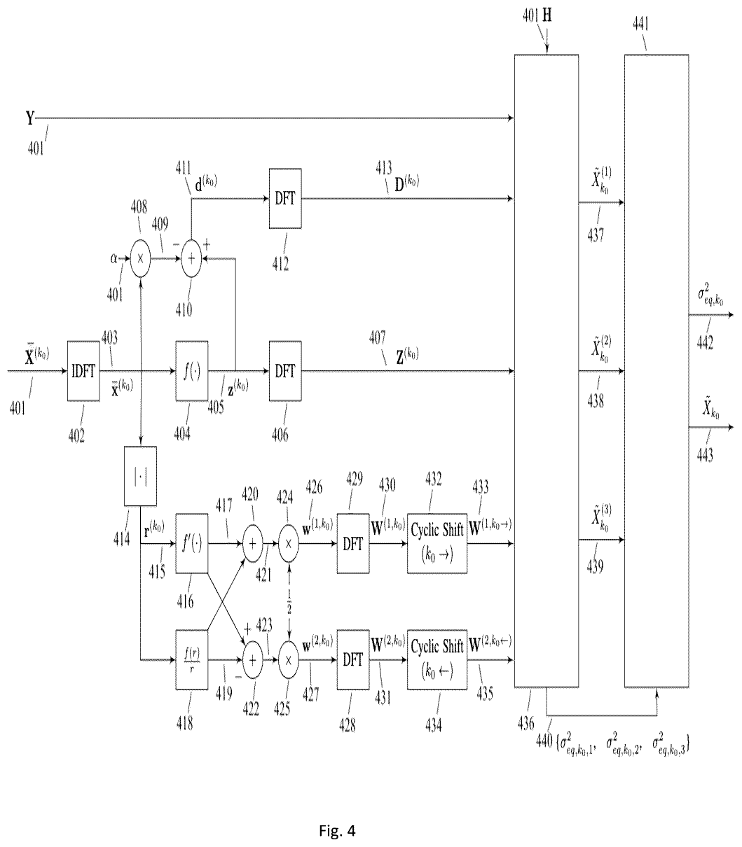

Block diagram 400 of FIG. 4 is an example that illustrates an exemplary apparatus embodiment implementing the blocks 304-1, 304-2 to 304-N of FIG. 3. In the example of FIG. 4, it is received as input 401-1 the signal Y, as input 401-2 the average symbols values X̅^{(k}^{₀}⁾ in signals 303-1, 303-2 or 303-N of FIG. 3 and an input signal 402-3 with the GASF value ∝. Independently of the value of k₀ the Inverse Fourier Transform is applied to the signal by the inverse fast Fourier Transform (IFFT) block 402 obtaining the signal in time domain 403. Block 404 calculates signal z^{(k}^{₀}⁾ 405 using f(x) which is the bandpass nonlinearity function. To obtain signal 405 in the frequency domain 407, is used block 406 to compute the discrete Fourier Transform (DFT).

To compute signal 411 with the nonlinear distortion d^{(k}^{₀}⁾ both the multiplication block 401 and the subtraction block 410 are used in complement with the input signal 401-3 with GASF value ∝, being the expression for this computation given by:

$${d}^{( {k}_{0} )} = {z}^{( {k}_{0} )} - ∝ {x}^{( {k}_{0} )}$$

Block 412 computes the DFT of signal 411 and generates the frequency domain signal 413.

To calculate signal 415 the block 414 is used in order to calculate the absolute value of signal 403. The signals 417 and 419 and computed by blocks 416 and 418 that calculate the derivative of the nonlinearity of the input and the ratio between the nonlinearity of input value and the input itself respectively. The block 420 and 422 adds and subtracts signals 417 and 419 respectively. Blocks 424 and 425 have the same role of reduce to half its inputs 421 and 423, respectively. In total the blocks 414-425 generate the signals 426 and 427:

$${w}^{( 1 , {k}_{0} )} = \frac{{f}^{′} ( \vert {\overline{x}}^{( {k}_{0} )} \vert ) + \frac{f ( \vert {\overline{x}}^{( {k}_{0} )} \vert )}{\vert {\overline{x}}^{( {k}_{0} )} \vert}}{2} and {w}^{( 2 , {k}_{0} )} = \frac{{f}^{′} ( \vert {\overline{x}}^{( {k}_{0} )} \vert ) - \frac{f ( \vert {\overline{x}}^{( {k}_{0} )} \vert )}{\vert {\overline{x}}^{( {k}_{0} )} \vert}}{2} .$$

To obtain signal 426 and 427 in the frequency domain 430 and 431, block 428 and 429 that compute the DFT are used. Block 432 computes a cyclic rotation of

$$- \frac{N}{2} + {k}_{0} - 1 ,$$

while block 434 computes a cyclic rotation in the opposite direction.

To compute the three different estimates of \tilde{X}ₖ_{₀} 437, 438 and 439 the block 436 uses the signals 401-2, 401-3, 407, 413, 433 and 435 to make the following calculations:

$${\tilde{X}}_{{k}_{0}}^{( 1 )} = \frac{{( {H}^{( 1 )} )}^{H} \times {V}^{( {k}_{0} )}}{{‖ {H}^{( 1 )} ‖}^{2}} ,$$

$${\tilde{X}}_{{k}_{0}}^{( 2 )} = \frac{{( {V}^{( {k}_{0} )} )}^{H} \times ( {H}^{( 2 )} )}{{‖ {H}^{( 2 )} ‖}^{2}} ,$$

$${\tilde{X}}_{{k}_{0}}^{( 3 )} = \frac{{Y}_{{k}_{0}} - {H}_{{k}_{0}} \times {D}_{{k}_{0}}^{( {k}_{0} )}}{∝ {H}_{{k}_{0}}} ,$$

where V^{(k}^{₀}⁾ is an auxiliar vector that depends on k₀ and is given by:

$${V}^{( {k}_{0} )} = \{ \begin{matrix}{Y}_{k} - {H}_{k} \times {Z}_{k}^{( {k}_{0} )} , & k \neq {k}_{0} \\ 0 , & k = {k}_{0}\end{matrix} .$$

Additionally, the vectors H⁽¹⁾ and H⁽²⁾ can be calculated using signals 433 and 435 as:

$${H}_{k}^{( 1 )} = {H}_{k} \times {W}_{k}^{( 1 , {k}_{0} \to )} and {H}_{k}^{( 2 )} = {H}_{k} \times {W}_{k}^{( 2 , {k}_{0} ← )} ,$$

The variances of each estimative of each \tilde{X}ₖ_{₀}⁽ⁱ⁾ estimates 440 are also computed by block 436 using the following expressions:

$${σ}_{eq , {k}_{0} , 1}^{2} = \frac{{σ}_{N}^{2}}{{‖ {H}^{( 1 )} ‖}^{2}} + {σ}_{X}^{2} \times {\vert \frac{{( {H}^{( 1 )} )}^{H} {H}^{( 2 )}}{{‖ {H}^{( 1 )} ‖}^{2}} \vert}^{2} ,$$

$${σ}_{eq , {k}_{0} , 2}^{2} = \frac{{σ}_{N}^{2}}{{‖ {H}^{( 2 )} ‖}^{2}} + {σ}_{X}^{2} \times {\vert \frac{{( {H}^{( 1 )} )}^{H} {H}^{( 2 )}}{{‖ {H}^{( 2 )} ‖}^{2}} \vert}^{2} ,$$

$${σ}_{eq , {k}_{0} , 3}^{2} = \frac{{σ}_{N}^{2}}{{\vert ∝ \times {H}_{{k}_{0}} \vert}^{2}} .$$

Block 441 computes the improved estimative \tilde{X}ₖ_{₀} 443 of the subcarrier ko and its respective variance σ²_{eq,k}_{₀} 442, these values can be obtained by the following expressions:

$${\tilde{X}}_{{k}_{0}} = ( \frac{{\tilde{X}}_{{k}_{0}}^{( 1 )}}{{σ}_{eq , {k}_{0} , 1}^{2}} + \frac{{\tilde{X}}_{{k}_{0}}^{( 2 )}}{{σ}_{eq , {k}_{0} , 2}^{2}} + \frac{{\tilde{X}}_{{k}_{0}}^{( 3 )}}{{σ}_{eq , {k}_{0} , 3}^{2}} ) \times {σ}_{eq , {k}_{0}}^{2} ,$$

$${σ}_{eq , {k}_{0}}^{2} = {( \frac{1}{{σ}_{eq , {k}_{0} , 1}^{2}} + \frac{1}{{σ}_{eq , {k}_{0} , 2}^{2}} + \frac{1}{{σ}_{eq , {k}_{0} , 3}^{2}} )}^{- 1} .$$

In another embodiment a digital filtering is used to remove the out-of-band radiation associated with the NL distortion effects, by replacing the samples Zₖ by Zₖ×Fₖ, where Fₖ=0 for the out-of-band subcarriers and 1 for the in-band subcarriers. This filtering effect can also be instead included in Hₖ (i.e., by replacing Hₖ by Hₖ×Fₖ).

In another embodiment an analog filter is used to remove the out-of-band radiation associated with the NL distortion effects.

The present disclosure relates generally to the orthogonal frequency division multiplexing (OFDM) apparatus for use in both coded and uncoded schemes in telecommunication systems. More particularly, the present disclosure relates to a receiver capable of taking advantage of the strong nonlinear distortion effects and exploit the frequency diversity introduced by the nonlinear operation at the transmitter. The receiver apparatus estimates iteratively the signal associated to a given subcarrier using the contributions from the received signals associated to all subcarriers, as well as the estimates of transmitted signals of those subcarriers from the previous iteration.

The scope of the present disclosure covers the use of unique iterative block that iterates through an estimative of the signal using a conditional detection of a given subcarrier which is able to exploit the frequency diversity introduced by the nonlinear operation at the transmitter, and implementations of such variations will be apparent to persons skilled in the art based on the teachings contained herein.

While various embodiments consistent with the disclosure have been described above, it should be understood that embodiments have been presented by way of example only, and not limitation. Thus, the breadth and scope of the present disclosure should not be limited by any of the above-described exemplary embodiments but should be defined only in accordance with the following claims and their equivalents. Various variations and modifications may be made without departing from the scope of the present disclosure. It should be understood by those skilled in the art that various modifications, combinations, sub-combinations, and alterations may occur depending on design requirements and other factors insofar as they are within the scope of the appended claims or the equivalents thereof.

Furthermore, the blend of various algorithms and designs provided in the disclosure impart unique aspects to embodiments that have been constructed consistent with the disclosure, and this permits approximating the optimum performance in the presence of nonlinear distortion which the state-of-the-art receivers aren't capable of do allowing performance gains of several decibels (dBs).

Embodiments consistent with the disclosure can be implemented purely digitally using only samples of the received signal and assuming the channel is known as well as the nonlinearity function used in the transmitter. In function of the application the embodiments of this disclosure can be implemented with or without channel decoder.

### FURTHER INFORMATION CONCERNING THE DISCLOSURE

Certain patents and publications concerning orthogonal frequency division multiplexing signals, some describing strong nonlinear distortion effects, include the following:
[1] L. Cimini, “Analysis and simulation of a digital mobile channel using orthogonal frequency division multiplexing,” IEEE Trans. Commun., vol. 33, no. 7, pp. 665-675, July 1985.
[2] H. Tataria, M. Shafi, A. F. Molisch, M. Dohler, H. Sjöland and F. Tufvesson, “6G Wireless Systems: vision, requirements, challenges, insights, and opportunities,” Proc. of IEEE, vol. 109, no. 7, pp. 1166-1199 July 2021.
[3] T. Hwang, C. Yang, G. Wu, S. Li and G. Ye Li, “OFDM and its wireless applications: A survey,” IEEE Transactions on Vehicular Technology, vol.58, no. 4, pp. 1673-1694 May 2009.
[4] D. Wulich, “Definition of efficient PAPR in OFDM,” IEEE Communications Letters, vol. 9, no. 9, pp. 832-834, September 2005.
[5] T. Jiang and Y. Wu, “An overview: peak-to-average power ratio reduction techniques for OFDM signals,” IEEE Transactions on Broadcasting, vol.54, no. 2, pp. 257-268, June 2008.
[6] J. Joung, C. Ho, and S. Sun, “Spectral efficiency and energy efficiency of OFDM systems: impact of power amplifiers and countermeasures,” IEEE J. Sel. Areas Commun., vol. 32, no. 2, pp. 208-220, February 2014.
[7] D. López-Pérez et al., “A Survey on 5G Radio Access Network Energy Efficiency: Massive MIMO, Lean Carrier Design, Sleep Modes, and Machine Learning,” IEEE Communications Surveys & Tutorials, vol. 24, no. 1, pp. 653-697, First Quarter 2022.
[8] D. Dardari, “Joint clip and quantization effects characterization in OFDM receivers,” IEEE Transactions on Circuits and Systems I: Regular Papers, vol. 53, no. 8, pp. 1741-1748 August 2006.
[9] X. Li and L. J. Cimini, “Effects of clipping and filtering on the performance of OFDM,” IEEE Comm. Let., vol. 2, no. 5, May 1998.
[10] O. Gouba and Y. Louët, “Theoretical analysis of the trade-off between efficiency and linearity of the high power amplifier in OFDM context,” Proc. of European Wireless 2012; 18th European Wireless Conference 2012, Poznan, Poland, April 2012.
[11] W. Wu, C.-S. Yang, I.-K. Fu, P.-K. Liao, D. Calin and M. Fan, “Revisiting the system energy footprint and power efficiency on the way to sustainable 6G systems,” IEEE Wireless Communications, vol. 29, no. 6, pp. 6-8, December 2022.
[12] E. Costa, M. Midrio and S. Pupolin, “Impact of amplifier nonlinearities on OFDM transmission system performance,” IEEE Communications Letters, vol. 3, no. 2, pp. 37-39, February 1999.
[13] G. Zhou, “Analysis of spectral regrowth of weakly nonlinear power amplifiers,” IEEE Communications Letters, vol. 4, no. 11, pp. 357-359, November 2000.
[14] H. Ochiai and H. Imai, “On the distribution of the peak-to-average power ratio in OFDM signals,” IEEE Transactions on Communications, vol. 49, no. 2, pp. 282-289, February 2001.
[15] J. Bussgang, “Cross-correlation functions of amplitude-distorted Gaussian signals,” M.I.T. RLE Technical Report, no. 216, pp. 1-14, March 1952.
[16] Y. Sun and H. Ochiai, “Performance analysis and comparison of clipped and filtered OFDM systems with iterative distortion recovery techniques,” IEEE T. Wireless Comm., vol. 20, no. 11, pp. 7389-7403 November 2021.
[17] F. Peng and W. Ryan, “MLSD bounds and receiver designs for clipped OFDM channels,” IEEE Trans. Wireless Commun., vol. 7, no. 9, pp. 3568-3578 September 2008.
[18] J. Guerreiro, R. Dinis, and P. Montezuma, “Optimum and sub-optimum receivers for OFDM signals with strong nonlinear distortion effects,” IEEE Trans. Commun., vol. 91, no. 9,pp. 3830-3840 September 2013.
[19] J. Guerreiro, R. Dinis, and P. Montezuma, “On the optimum multicarrier performance with memoryless nonlinearities,” IEEE Trans. Commun., vol. 63, no. 2, pp. 498-509, February 2015.
[20] D. Macedo, J. Guerreiro, R. Dinis, S. Hu, “On the design of nonlinear characteristics that optimize maximum likelihood OFDM performance,” IEEE T. on Vehicular Technology, Vol. 1, No. 1, pp. 1-6, July 2023.
[21] J. Guerreiro, M. Beko, R. Dinis, and P. Montezuma, “Using the Fireworks Algorithm for ML Detection of Nonlinear OFDM,” IEEE VTC'2017 (Fall), Toronto, Canada, September 2017
[22] S. Zhidkov and R. Dinis, “Belief propagation receivers for near-optimal detection of nonlinearly distorted OFDM signals,” in Proc. of IEEE VTC'19 (Spring), Kuala Lumpur, Malaysia, May 2019.
[23] C. Yang, X. Liu, Y. L. Guan and R. Liu, “Fast GAMP algorithm for nonlinearly distorted OFDM signals,” IEEE Commun. Lett., vol. 25. no. 5. pp. 1682-1686. May 2021.
[24] R. Dinis and P. Silva, “Analytical Evaluation of Nonlinear Effects in MC-CDMA Signals,” IEEE Trans. on Wireless Comm., Vol. 5, No. 8, pp. 2277-2284. August 2006.

What is claimed is:

1. A method for a receiver for orthogonal frequency division multiplexing signals in which strong nonlinear distortion effects are utilized to exploit the frequency diversity introduced by the nonlinear operation at the transmitter, comprising:
receiving a signal that represents the message that arrives at the receiver which can be given by Y=Z⊙H+N, where Z is the output of nonlinearly of the transmitted orthogonal frequency division multiplexing (OFDM) signal X, H is an estimative of the channel and N is the noise;
receiving a channel estimate H;
receiving a Gaussian approximation scale factor a associated with the nonlinearity introduced in the transmitter;
receiving information of both the constellation and the nonlinearity function used by the transmitter f( ) as well as the variance noise σ²_{N} and if channel coding was utilized and what type it was;
computing an equalization operation to the received signal;
calculating the average block of subcarrier symbols, which will be the first estimative of the signal X̅;
computing iteratively in each iteration improved estimates of the transmitted block of subcarriers where each block estimate is obtained by estimating successively or in parallel the transmitted signal associated to each subcarrier k₀, each time creating an auxiliar signal X̅^{(k}^{₀}⁾that represents X̅ without the subcarrier k₀ and its time-domain equivalent x̅^{(k}^{₀}⁾;
obtaining for each iteration an estimative of the output of nonlinearly of the transmitted signal Z^{(k}^{₀}⁾, an estimative of the distortion component added by the nonlinearity function D (ko), an estimative of the distribution of the transmitted symbol Xₖ_{₀} in each subcarrier W^{(1,k}^{₀}^{→)} and an estimative of the conjugate of the transmitted symbol Xₖ_{₀} in each subcarrier W^{(1,k}^{₀}^{←)}.
computing in each iteration, for each subcarrier ko three auxiliar estimative of the transmitted signal \tilde{X}ₖ_{₀}⁽¹⁾, \tilde{X}ₖ_{₀}⁽²⁾ and \tilde{X}ₖ_{₀}⁽³⁾, one of them by removing the estimation of the distortion, a second one by using the components of X̅ₖ_{₀} on the different subcarriers and a third one by using the components of the conjugate of the X̅ₖ_{₀} on the different subcarriers, additionally the respective variances σ²_{eq,k}_{₀}_{,1}, σ²_{eq,k}_{₀}_{,2} and σ²_{eq,k}_{₀}_{,3} and combines them in a single improved estimate \tilde{X}ₖ_{₀}, as well as its variance 02 eq,ko; and
calculating in each iteration the average block of subcarrier symbols that will be used in the next iteration of the receiver X̅.

2. The method according to claim 1, wherein said step of receiving said input signal carrying the message comprises:
receiving the OFDM signal Y=[0, . . . , 0, Y₁, Y₂, . . . , Y_{N}, 0, . . . , 0], including N subcarriers of data and potential additional zeros of oversampling.

3. The method according to claim 1, wherein said calculation of the average block of subcarrier symbols comprises:
a M-quadrature amplitude modulation (M-QAM) demodulator adequate to the constellation transmitted, a channel decoder adequate to the employed channel coding technique used and a converter that turns Log-Likelihood Ratios into average symbols.

4. An apparatus for a receiver for orthogonal frequency division multiplexing signals in which strong nonlinear distortion effects are utilized to exploit the frequency diversity introduced by the nonlinear operation at the transmitter, comprising:
an input circuitry receiving an input signal that represents the message that arrives at the receiver which can be given by Y=Z⊙H+N, where Z is the output of nonlinearly of the transmitted orthogonal frequency division multiplexing (OFDM) signal X, H is an estimative of the channel and N is the noise, receiving a channel estimate H, receiving a Gaussian approximation scale factor α associated with the nonlinearity introduced at transmitter;
a circuitry receiving information of both the constellation and the nonlinearity function used by the transmitter f( ) as well as the variance noise σ²_{N} and information about if channel coding was used and what kind of coding was applied;
a circuitry that performs an equalization operation to the received signal and the average block of subcarrier symbols, which will be the first estimative of the signal X̅;
a circuitry of improved estimates that computes iteratively in each iteration improved estimates of the transmitted block of subcarriers where each block estimate is obtained by estimating successively or in parallel the transmitted signal associated to each subcarrier ko, each time creating an auxiliar signal X̅^{(k}^{₀}⁾that represents X̅ without the subcarrier k₀ and its time-domain equivalent x̅^{(k}^{₀}⁾;
the computation for each iteration in the circuitry of improved estimates of an estimative for the output of nonlinearly of the transmitted signal Z^{(k}^{₀}⁾, an estimative of the distortion component added by the nonlinearity function D^{(k}^{₀}⁾, an estimative of the distribution of the transmitted symbol Xₖ_{₀} in each subcarrier W^{(1,k}^{₀}^{→)} and an estimative of the conjugate of the transmitted symbol Xₖ_{₀} in each subcarrier W^{(2,k}^{₀}^{←)}; and
the computation for computation for each iteration in the circuitry of improved estimates, for each subcarrier ko of three auxiliar estimative of the transmitted signal \tilde{X}ₖ_{₀}⁽¹⁾, \tilde{X}ₖ_{₀}⁽²⁾ and \tilde{X}ₖ_{₀}⁽³⁾, one of them by removing the estimation of the distortion, a second one by using the components of X̅ₖ_{₀} on the different subcarriers and third one by using the components of the conjugate of the X̅ₖ_{₀} on the different subcarriers, additionally the respective variances σ²_{eq,k}_{₀}₁, σ²_{eq,k}_{₀}₂ and σ²_{eq,k}_{₀}₃ and combines them in a single improved estimate \tilde{X}ₖ_{₀}, as well as its variance σ²_{eq,k}_{₀} and calculates in each iteration the average block of subcarrier symbols that will be used in the next iteration of the receiver X̅.

5. The apparatus of claim 4, wherein said input signal comprises:
an OFDM signal Y=[0, . . . , 0, Y₁, Y₂, . . . , Y_{N}, 0, . . . , 0], including N subcarriers of data and potential additional zeros of oversampling.

6. The apparatus of claim 4, wherein said circuitry that performs the equalization and the computation of average block of subcarrier symbols comprises:
a M-quadrature amplitude modulation (M-QAM) demodulator block, a channel decoder adequate to the employed channel coding technique used and a converter that turns Log-Likelihood Ratios into average symbols.

7. The apparatus of claim 4, wherein said estimative of the output of nonlinearly of the transmitted signal Z^{(k}^{₀}⁾is obtained by computing Fourier Transform of the output of the nonlinear function of x̅^{(k}^{₀}⁾.

8. The apparatus of claim 4, wherein said estimative of the output of nonlinearly of the transmitted signal D^{(k}^{₀}⁾ is obtain by computing the Fourier Transform of fx̅^{(k}^{₀}⁾)−∝x̅^{(k}^{₀}⁾).

9. The apparatus of claim 4, wherein said estimation of the distribution of the transmitted symbol Xₖ_{₀} in each subcarrier W^{(1,k}^{₀}^{→)} is obtained by a shifted version of the Fourier Transform of
$$\frac{{f}^{′} ( \vert {\overline{x}}^{( {k}_{0} )} \vert ) + \frac{f ( \vert {\overline{x}}^{( {k}_{0} )} \vert )}{\vert {\overline{x}}^{( {k}_{0} )} \vert}}{2} ,$$
where f′( ) is the derivative of the nonlinear function f( )

10. The apparatus of claim 4, wherein said estimative of the distribution of conjugate of the transmitted symbol Xₖ_{₀} in each subcarrier W^{(2,k}^{₀}^{←)} is obtained by a shifted version of the Fourier Transform of
$$\frac{{f}^{′} ( \vert {\overline{x}}^{( {k}_{0} )} \vert ) - \frac{f ( \vert {\overline{x}}^{( {k}_{0} )} \vert )}{\vert {\overline{x}}^{( {k}_{0} )} \vert}}{2} ,$$
where f′( ) is the derivative of the nonlinear function f( )

11. The apparatus of claim 4, wherein said three auxiliar estimates of the transmitted signal \tilde{X}ₖ_{₀}⁽¹⁾, \tilde{X}ₖ_{₀}⁽²⁾ and \tilde{X}ₖ_{₀}⁽³⁾ are obtained by
$${\tilde{X}}_{{k}_{0}}^{( 1 )} = \frac{{( {H}^{( 1 )} )}^{H} \times {V}^{( {k}_{0} )}}{{‖ {H}^{( 1 )} ‖}^{2}} , {\tilde{X}}_{{k}_{0}}^{( 2 )} = \frac{{( {V}^{( {k}_{0} )} )}^{H} \times ( {H}^{( 2 )} )}{{‖ {H}^{( 2 )} ‖}^{2}} and$$
$${\tilde{X}}_{{k}_{0}}^{( 3 )} = \frac{{Y}_{{k}_{0}} - {H}_{{k}_{0}} \times {D}_{{k}_{0}}^{( {k}_{0} )}}{∝ {H}_{{k}_{0}}} ,$$
where Hₖ⁽¹⁾=Hₖ×Wₖ^{(2,k}^{₀}^{←)}, Hₖ⁽²⁾32 Hₖ×Wₖ^{(2,k}^{₀}^{←)} and
$${V}^{( {k}_{0} )} = \{ \begin{matrix}{Y}_{k} - {H}_{k} \times {Z}_{k}^{( {k}_{0} )} , & k \neq {k}_{0} \\ 0 , & k = {k}_{0}\end{matrix} .$$

12. The apparatus of claim 4, wherein said improved estimate \tilde{X}ₖ_{₀} and its variance σ²_{eq,k}_{₀} is computed using Maximum Ratio Combining detection of \tilde{X}ₖ_{₀}⁽¹⁾, \tilde{X}ₖ_{₀}⁽²⁾ and \tilde{X}ₖ_{₀}⁽³⁾ and their respective variances σ²_{eq,k}_{₀}₁, σ²_{eq,k}_{₀}₂ and σ²_{eq,k}_{₀}₃.

13. The apparatus of claim 4, further comprising a digital filter at the input circuitry, to mitigate out-of-band radiation associated with nonlinearity distortion effects.

14. The apparatus of claim 4, further comprising an analog filter in the input circuitry, to mitigate out-of-band radiation associated with nonlinearity distortion effects.

15. The apparatus of claim 4, wherein said the nonlinearity function f( ) used by the transmitter operates on either digital signals, with or without oversampling, or analog signals.
